(19) United States
(12) Patent Application Publication
(10) Pub. No.: US 2026/0077432 A1
(43) Pub. Date: Mar. 19, 2026

(54) METHOD FOR SURFACE-TREATING A FUNCTIONAL SURFACE OF A COOKING APPARATUS, AND COOKING APPARATUS FOR COOKING FOOD TO BE COOKED

(71) Applicant: Surfunction GmbH, Saarbruecken (DE)

(72) Inventors: Dominik BRITZ, Wallerfangen (DE); Andrés Fabian LASAGNI, Grumbach (DE)

(73) Assignee: Surfunction GmbH, Saarbruecken (DE)

(21) Appl. No.: 19/401,459

(22) Filed: Nov. 26, 2025

Related U.S. Application Data
(63) Continuation of application No. PCT/EP2024/064033, filed on May 22, 2024.

(30) Foreign Application Priority Data
May 26, 2023 (DE) 10 2023 113 923.1
May 26, 2023 (DE) 20 2023 102 922.1

(51) Int. Cl. B23K 26/352; A47J 36/02; B23K 26/0622

(52) U.S. Cl. CPC B23K 26/355; A47J 36/025; B23K 26/0624

(57) ABSTRACT

A method for surface treating a functional surface of a cooking apparatus for cooking food to be cooked. The method according to the invention can include: structuring the functional surface via a laser-processing apparatus, the functional surface being structured by at least one laser beam, the at least one laser beam comprising at least temporary pulse durations of at most 500 ns, and the structuring producing a profile having at least one indentation, applying a lubricant to the structured functional surface, thermally treating the structured functional surface having the lubricant at a temperature between 50° C. and 700° C. in order to obtain the treated functional surface. The cooking apparatus according to the invention has a functional surface treated in accordance with the method according to the invention.

This nonprovisional application is a continuation of International Application No. PCT/EP2024/064033, which was filed on May 22, 2024, and which claims priority to German Patent Application No. 10 2023 113 923.1, which was filed in Germany on May 26, 2023, and German Patent Application No. 20 2023 102 922.1, which was filed in Germany on May 26, 2023, and which are both herein incorporated by reference.

### BACKGROUND OF THE INVENTION

### Field of the Invention

The invention relates to a method for surface-treating a functional surface of a cooking apparatus for cooking food to be cooked, as well as a cooking apparatus for cooking food to be cooked.

### Description of the Background Art

Cooking apparatuses are known from the prior art, e.g., as stainless steel pots for cooking food to be cooked, wherein the functional surface of the stainless steel pot is smooth due to polishing carried out during its manufacture. After prolonged use, the functional surface is subject to unevenness due to scratches and dirt stains, such that food residue from the food to be cooked remains stuck on the functional surface of the stainless steel pot, and it is difficult to clean.

Methods are known from the prior art for improving the non-stick properties of cooking apparatuses. To this end, EP 0 365 458, which corresponds to U.S. Pat. No. 5,085,062, provides a roughened functional surface onto which a ceramic material, e.g., an aluminum oxide/titanium oxide powder mixture, is thermally sprayed. EP 1 048 751 provides for coating a functional surface with diamond crystals to obtain a hard and thermally well-conducting coating. Furthermore, coatings of functional surfaces are known that contain per-and polyfluoroalkyl compounds, which are also known as “PFAS” (“per-and polyfluoroalkyl substances”). While these components improve the non-stick properties of the functional surface, they are highly harmful to health and the environment.

Due to the comparatively macroscopic manufacturing processes for creating indentations in the functional surface of the cooking apparatuses, known cooking apparatuses from the prior art exhibit indentations with a largely uncontrolled distribution of dimensions. The dimensions of the indentations are highly statistically distributed and subject to large fluctuations. Furthermore, the known coatings of the functional surfaces are neither sustainable nor durable. In most cases, with increasing usage time of the known cooking apparatuses, the non-stick surface and/or the functional surface of the cooking apparatus itself comes off or wears out such that the non-stick properties of the known cooking apparatuses are severely impaired after a longer period of use.

### SUMMARY OF THE INVENTION

It is therefore an object of the present invention to provide a method for surface-treating a functional surface of a cooking apparatus as well as a corresponding cooking apparatus in order to obtain improved non-stick properties of the cooking apparatus, in particular for a longer service life of the cooking apparatus and with a lower impact on the environment.

The object of the invention is achieved, in an example, by a method for surface treating a functional surface of a cooking apparatus for cooking food to be cooked, having the following steps: providing the cooking apparatus in a laser-processing apparatus; structuring the functional surface of the cooking apparatus by means of the laser-processing apparatus, wherein the laser-processing apparatus structures the functional surface by at least one laser beam, wherein the at least one laser beam has pulse durations of at most 500 ns at least temporarily, and wherein a profile with at least one indentation is created on the functional surface by means of the structuring; applying a lubricant to the structured functional surface; and thermally treating the structured functional surface having the lubricant at a temperature between 50° C. and 700° C. in order to obtain the treated functional surface.

The object of the invention is also achieved, in an example, by a cooking apparatus having with a functional surface for cooking food to be cooked, wherein the functional surface is treated according to the method according to the invention.

By structuring the functional surface of the cooking apparatus according to the invention by means of the at least one laser beam within the laser-processing apparatus, it is ensured that the at least one indentation, in particular all of the designed indentations, are formed with an identical dimension within the manufacturing tolerance. The formation of the at least one indentation of the profile is therefore reproducible, in particular with regard to a plurality of indentations of the same profile and/or with regard to a plurality of cooking apparatuses structured successively according to the invention.

For example, the structuring of the functional surface can be done by means of a single laser beam, which is also known as “direct laser writing.” To structure the functional surface, the laser beam can be focused on the position of the processing of the functional surface to increase the energy and power density. The structuring of the functional surface can provide for the laser beam to be moved relative to the functional surface, which is also referred to as “rasterizing.” This can be done, for example, by means of a laser scanner, in particular by means of a mirror scanner, which can be designed as a galvo scanner and/or as a polygon scanner. The laser scanner is preferably designed for one-or two-dimensional deflection of the at least one laser beam. In a further embodiment of the invention, the functional surface of the cooking apparatus can be moved translationally—relative to the at least one, in particular stationary, laser beam—for example, by means of at least one servo motor. In a particularly advantageous further development of the invention, the at least one laser beam and the cooking apparatus are movable in one and/or two dimensions in order to be able to perform a particularly fast structuring of the functional surface.

To increase process efficiency, at least two laser beams can also be used in the sense of the “direct laser writing” described above to structure the functional surface. In a further development of this feature, a plurality of laser sources of the laser-processing apparatus connected in parallel can be used to generate the at least two laser beams in order to structure the functional surface. Preferably, the number of laser beams corresponds to the number of laser sources of the laser-processing apparatus. In an alternative embodiment, the laser-processing apparatus has a laser source whose beam, which is also called the “seed beam,” is split into at least two partial beams—for example, by using diffractive optical elements. The partial beams obtained on the basis of the original laser beam of the laser beam source can be used to structure the functional surface, wherein it can be provided that at least one of the partial beams, in particular a plurality of partial beams, be focused independently of each other. The at least two laser beams of the laser-processing apparatus can be in a specific spatial relationship to each other, in particular in the already described use of diffractive optical elements.

It can be provided that the pulse duration over time of at least one laser beam be at most 15 ps. This ensures that thermal effects during the creation of the profile are prevented as much as possible, which improves the manufacturing quality of the indentations. Furthermore, the formation of melts and thermally induced material damage, in particular stress cracks, is prevented. It is known that, with shorter pulse durations, thermal effects are increasingly neglected, such that the functional surface of the cooking apparatus is increasingly mechanically processed. This effect is therefore also called cold ablation. From this point of view, it can be provided that the temporal pulse duration of the laser beams be at most 10 ps so that even fewer thermal effects occur. In addition, the accuracy of the structuring is improved.

For the same reason, it can be provided that the temporal pulse duration of the laser radiation be at most 1 ps, whereby an even better surface quality of the functional surface can be obtained. Preferably, a temporal pulse duration between 100 fs and 15 ps, in particular between 100 fs and 1 ps, is provided.

Furthermore, the power of the laser radiation can be between 1 W and 5 kW, in particular between 1 W and 500 W, and/or the energy of the pulses of the laser radiation can be between 10 μJ and 200 mJ, in particular 10 μJ and 100 mJ. The at least one laser beam can have a beam diameter between 2 μm and 6 μm when structuring the functional surface, in particular in the region of the functional surface. When creating the structuring as per the invention, between 2 and 1,000 individual pulses can be superimposed in a spatial region in order to obtain high structural aspect ratios by means of correspondingly high material removal.

Furthermore, it can be provided that exactly two laser beams that interfere with each other be used to structure the functional surface of the cooking apparatus by means of the laser-processing apparatus. A further development of the invention provides for the use of three laser beams that interfere with one another, whereby, for example, the functional surface can be structured having indentations in a hexagonal pattern. In this case, the structuring has three axes along the surface, along which the indentations are each arranged in a lateral period, wherein, in the sense of the invention, each of the lateral periods for the three axes in the hexagonal pattern are identical. In addition, four laser beams that interfere with one another can be used to create a square pattern of indentations when structuring the functional surface. Finally, it may be provided that a maximum of nine laser beams that interfere with one another be used.

The structuring of the functional surface increases the surface due to the at least one indentation, and allows for better wetting of the functional surface by the lubricant. According to the applicant's knowledge, in the case of the functional surface structured according to the invention, the lubricant is “drawn into” the indentations by means of capillary forces occurring in the microstructure range and remains stored there at least temporarily. This improves the non-stick properties compared to the known cooking apparatus.

Another basic idea of the invention is that polymerizations, oxidations, and hydrolyses can occur by thermally treating the lubricant, which is introduced in particular into the functional surface structured according to the invention. This causes reaction products to be deposited in the at least one indentation of the profile of the functional surface and, due to the aforementioned increase in surface region, adhere particularly well to the functional surface, such that the applied lubricant forms a lubricating film, which is also referred to as a tribofilm. Due to the structuring of the functional surface according to the invention, these properties are particularly durable and protect the topography of the functional surface from mechanical wear for as long as possible. The invention therefore enables the creation of an environmentally friendly and durable cooking apparatus with stable non-stick properties even after prolonged use. Furthermore, no further cleaning steps are required according to the method according to the invention, such that the cooking apparatus surface-treated according to the invention is immediately ready to use after the end of the method.

Preferably, the structuring of the functional surface of the cooking apparatus is carried out by means of the laser-processing apparatus by means of interference between at least two laser beams. By using at least two laser beams that interfere with each other to structure the functional surface, a large region of the functional surface can be processed in a comparatively short time, so that, as a result, the process efficiency of the surface structuring in the course of the method according to the invention is also improved. In particular, the functional surface of the cooking apparatus can be provided with a full-surface surface structuring in the micro-and/or nanometer scale range in a short processing time, which leads to a significantly higher process efficiency and therefore lower manufacturing costs compared to other known treatment methods.

In the sense of the invention, the cooking apparatus includes all utensils for cooking foods, such as frying, cooking, grilling, baking, roasting, and braising utensils. The functional surface refers to the surface of the cooking apparatus that comes into contact with the food, i.e., the food to be cooked during the cooking process. In the sense of the invention, cooking includes, on the one hand, wet cooking techniques in which the food is cooked with the help of drinking water—for example, boiling or steaming. In addition, cooking also includes dry cooking techniques in which the food to be cooked is cooked without the addition of drinking water—for example, roasting, baking, or grilling.

Preferably, the at least one laser beam, in particular the at least two laser beams that interfere with each other, has at least temporary pulse durations between 1 ns and 20 ns in order to attain a higher processing speed when structuring the functional surface. Furthermore, the use of pulse durations between 1 ns and 20 ns allows for the structuring of the functional surface with a higher depth of field, i.e., greater flexibility in structuring the functional surface along the depth.

Preferably, it is provided that the at least one indentation of the functional surface be produced having a dimension, in particular a depth relative to an unstructured region of the functional surface, of between 10 nm and 50 μm, in particular between 100 nm and 15 μm, or between 1 μm and 25 μm. In further embodiments of the invention, it can be provided that the dimension of the indentation correspond to its length in the x- and/or y-direction, wherein, in the sense of the invention, in the case of a plurality of indentations, the y-direction corresponds to the direction in which the indentations are offset, while the x-direction is perpendicular thereto. The x- and y-directions are each perpendicular to the normal of the functional surface and therefore each extend along the functional surface. In the sense of the invention, the dimension can also be a direction as a combination of the x-and y-directions, which in this respect generally corresponds to a lateral direction.

At least two indentations can be produced having substantially identical dimensions, in particular substantially identical depths. In the sense of the invention, two dimensions have substantially identical dimensions if the deviations therefrom do not exceed the processing tolerance that is customary in similar methods. At least two adjacent indentations can be arranged at a distance of 10 nm to 50 μm, in particular between 100 nm to 15 μm, or between 1 μm to 25μm. The functional surface, which is structured in this way, enables structural geometries on the cooking apparatus of an order of magnitude between 10 nm and 50 μm, in particular between 100 nm and 15 μm, or between 1 μm to 25 μm, to be realized on the workpiece at an industrially relevant processing speed, while at the same time ensuring reproducibility.

Preferably, at least one group of indentations can be produced in a periodic pattern on the functional surface, since this structure can be produced in particular very easily by means of the laser beams that interfere with one another. In the context of the present invention, the period refers to the distance between two identical structural features of different indentations of the periodic pattern, i.e., for example, the distance between the beginning of a first indentation of the periodic pattern and the beginning of the indentation adjacent to this indentation of the same periodic pattern. Alternatively or additionally, in the sense of the invention, the period can denote the distance between a center point of the first indentation of the periodic pattern and the center point of the indentation adjacent to this indentation of the same periodic pattern. Since the indentations of the periodic pattern are laterally offset, the invention also refers to the lateral period, which, as already mentioned, refers to the distance between recurring structural features of adjacent indentations of the periodic pattern.

Preferably, the group of indentations in the periodic pattern on the functional surface can be generated in at least one direction along the functional surface with a lateral period between 10 nm and 50 μm, in particular between 100 nm and 15 μm or between 1 μm and 25 μm. A periodic structuring of the functional surface with a lateral period of this order of magnitude allows for the formation of the advantageous surface functionalities mentioned at the outset, which the cooking apparatus is also to be provided with. Furthermore, the group of indentations in the periodic pattern can have different periods in different directions, e.g., when three, four, or more laser beams that interfere with one another are used to structure the functional surface. In an advantageous development, the group of indentations has identical periods in two different directions in the periodic pattern. Furthermore, it can be provided that the group of indentations have identical periods in three different directions in the periodic pattern, which corresponds, for example, to a hexagonal arrangement of the indentations. The group of indentations is formed, for example, as a sinusoidal line structure in which indentations and elevations are arranged one behind the other in the same lateral period each time.

At least one group of indentations be produced on the functional surface of the cooking apparatus can have a linear course and/or a rectangular, preferably square, basic shape and/or a circular basic shape. The basic shape of the indentations can be polygonal, in particular hexagonal. As a special case, the indentations can be designed as lines, which can be arranged in particular so as to be offset perpendicularly to their direction of extension and/or in a defined lateral period.

Preferably, the indentations, in particular the group of indentations, can have a lateral extent, in particular in a direction parallel to the direction of the lateral period, between 10 nm and 49 μm, in particular between 10 nm and 10 μm or between 1 μm and 25 μm, in order to attain particularly advantageous non-stick properties of the cooking apparatus. Particularly preferably, all indentations have a lateral extent of essentially 10 nm to 49 μm, in particular between 10 nm to 10 μm or between 1 μm and 25 μm.

Preferably the indentations, in particular the group of indentations, can have an aspect ratio between 0.01 and 5, in particular between 0.01 and 1, wherein the aspect ratio in the sense of the invention corresponds to the ratio of the depth of the indentation to a lateral extent of the indentation.

Preferably, the functional surface can be structured in a single work step to improve the efficiency of the method.

At least two first indentations, in particular a first group of indentations, can be produced having a first lateral period between 10 nm and 50 μm, in particular between 100 nm and 15 μm, or between 1 μm and 25 μm, and at least two second indentations, in particular a second group of indentations, be produced having a second lateral period, wherein the second lateral period in particular is smaller than the first lateral period. The first lateral period can be between 100 nm and 999 μm. However, the second lateral period can also be larger than or identical to the first lateral period. The second group of indentations may be mathematically similar to the first group of indentations such that the second group of indentations results from the first group of indentations by means of at least one mathematical similarity transformation-for example, translation, rotation, dilation, and/or scaling. Preferably, the second group of indentations corresponds to a rotation of the first group of indentations of 90°about an axis perpendicular to the tool surface.

At least two first indentations, in particular a first group of indentations, can be produced having a first dimension between 10 nm and 50 μm, in particular between 100 nm and 15 μm or between 1 μm and 25 μm, and at least two second indentations, in particular a second group of indentations, be produced having a second dimension, wherein the second dimension is in particular smaller than the first dimension. As already stated, in the sense of the invention, the dimension of the indentation may correspond to its depth.

In addition to the second indentations, at least two third indentations, in particular a third group of indentations, can be produced having a third lateral period and/or a third dimension, wherein the third lateral period and/or the third dimension is/are in particular smaller than the second lateral period and/or the second dimension. In developments, up to ten groups of indentations can be created, each with a lateral period and/or a dimension wherein in particular the lateral period and/or the dimension of a group is/are always smaller than the lateral period and/or the dimensions of the previous groups.

Preferably, the region of the second indentations, in particular of the second group of indentations, at least partially may overlap the region of the first indentations, in particular of the first group of indentations. The same applies to any third indentations that are created, in particular the third group of indentations. Such an overlap makes it possible to combine structures with different lateral periods and/or dimensions, in particular to modulate them in a mathematical sense, and to provide the functional surface of the cooking device with complex surface structures that are not possible with simple structuring. This expands the possibilities for improving the non-stick properties of the cooking apparatus.

Preferably, the first indentations, in particular the first group of indentations, and the second indentations, in particular the second group of indentations, can be created in a single work step or in separate work steps. The creation of the first indentations and the second indentations in a single work step results in an increase in processing speed. In contrast, the configuration in which the first indentations and the second indentations are created in separate work steps includes, in particular, the functional surface being structured with different interference patterns. For example, it can be provided that the cooking device be moved between two sequential work steps. Preferably, it can be provided that the cooking device rotate between two work steps, in particular by an angle of 90°, so that indentations can be formed particularly easily-for example, as cross-structure patterns and/or so-called Penrose structure patterns. The indentations of the second group may be arranged perpendicularly to the indentations of the first group such that the lateral period of the second group of indentations is perpendicular to the lateral period of the first group of indentations. In addition, the lateral period of the second group of indentations can be parallel to the lateral period of the first group of indentations or can form an angle between 0° and 180°.

Preferably, the second group of indentations can be created by a polarization of the laser beams selected on the basis of the material of the functional surface to be structured, whereby in particular laser-induced periodic surface structuring can be formed, in particular in a joint work step together with the formation of the first group of indentations. For example, the lateral period of the second group of indentations corresponds at most to the laser beam wavelength used. The polarization of the laser beams can be linear, wherein the polarization vector is substantially perpendicular to the direction of extension of the laser-induced periodic surface structuring and/or parallel to the lateral period associated with the laser-induced periodic surface structuring. In addition, the direction of the polarization vector of the laser beams can be at an angle of between 0° and 180° relative to the lateral period of the first group of indentations so that the arrangement of the second group of indentations, in particular relative to the first group of indentations, can be adjusted by orienting the polarization vector of the laser beams.

For example, it can be provided that the first indentations, in particular the first group of indentations, be produced by means of interference of the at least two laser beams, wherein the second indentations, in particular the second group of indentations, are created by means of interference of at least two laser beams and/or by means of a single laser beam. This means that the first indentations are always created by the laser beams that interfere with one another, while this does not necessarily have to be the case when creating the second indentations. The creation of the second indentations by means of a single laser beam can be useful if the number of second indentations is small compared to the number of first indentations and/or if the region of the second indentations is small compared to the region of the first indentations. If the second indentations are also created by means of laser beams that interfere with one another, it can be provided that the number of laser beams interfering with one another differ from or be identical to that used when creating the first indentations.

Preferably, at least two groups of indentations can be produced in a periodic pattern, wherein the lateral period of the first group of indentations is arranged at an angle other than 0° to the lateral period of the second group of indentations, in particular at an angle of 90°.

Preferably, the lubricant comprises at least one component from the following group: oil-containing lubricant, oil, food oil, vegetable oil, sunflower oil, rapeseed oil, food-grade chain oil, fat, food-grade fat, vegetable fat, animal fat, synthetic fat, polyalkylene glycol, dry lubricant, food-grade dry lubricant, solid lubricant, carbon-based lubricant, graphite. In the sense of the invention, lubricants that meet the classification H1 and/or the requirements of EC Directive 93/43 EEC can be considered food-grade. In the sense of the invention, lubricants are considered to be food-grade in particular if unintentional contact with food is possible and humanly tolerable. Food-grade lubricants can contain additives that are safe for human consumption and may be transferred to food only in limited quantities.

In particular, it can be provided that the preferably fat-containing lubricant be applied to the structured functional surface of the cooking apparatus in such a way that the lubricant forms a flat surface, which improves the non-stick properties of the cooking apparatus.

Preferably, the thermal treatment of the structured functional surface can be carried out for a duration of at least 1 minute.

The cooking apparatus according to the invention, in particular its functional surface, can have at least one component from the following group: aluminum, iron, cast iron, stainless steel, carbon steel, carbon steel, in particular provided with a magnetic component, ceramic, fiber-reinforced material.

Preferably, the cooking apparatus can have a layer system with at least two layers, wherein in particular a first layer of aluminum and a second layer of stainless steel are provided, wherein in particular the functional surface corresponds to the second layer.

Preferably, the functional surface of the cooking apparatus can have at least one group of indentations, wherein the indentations in particular have a lateral period between 100 nm and 50 μm, and/or a lateral dimension, in particular a lateral width between 10 nm and 49 μm, in particular between 10 nm and 10 μm or between 1 μm and 25 μm, and/or have an aspect ratio between 0.01 and 5, in particular between 0.01 and 1, wherein the aspect ratio corresponds to the ratio of the depth of the indentation to the lateral dimension of the indentation.

Preferably, the lubricant on the functional surface can have a layer thickness of between 10 nm and 500 μm after thermal treatment.

Preferably, the cooking apparatus can be, for example, a cooking apparatus, grilling apparatus, frying apparatus, baking apparatus, braising apparatus. The cooking apparatus can be, for example, a cooking pot, roasting pan, baking tray, frying pan, grill rack, etc.

Further scope of applicability of the present invention will become apparent from the detailed description given hereinafter. However, it should be understood that the detailed description and specific examples, while indicating preferred embodiments of the invention, are given by way of illustration only, since various changes, combinations, and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus, are not limitive of the present invention, and wherein:

FIG. 1 shows schematic representations of steps (a) to (d) of the method according to the invention in connection with a cooking apparatus according to the invention,

FIG. 2 shows a schematic representation of a structured functional surface of the cooking apparatus according to the invention,

FIG. 3 shows the functional surface according to FIG. 2 in a schematic section;

FIG. 4 shows the functional surface of FIG. 3 after applying a lubricant,

FIG. 5 shows a cooking pot with an untreated functional surface,

FIG. 6 shows the cooking pot according to FIG. 5 with the functional surface treated according to the invention,

FIG. 7 shows a baking tray with an untreated functional surface,

FIG. 8 shows the baking tray according to FIG. 7 with a functional surface treated according to the invention,

FIG. 9 shows a frying pan with an untreated functional surface,

FIG. 10 shows the frying pan according to FIG. 9 with the functional surface treated according to the invention,

FIG. 11 shows a grill rack with an untreated functional surface,

FIG. 12 shows the grill rack according to FIG. 11 with a functional surface treated according to the invention,

FIG. 13 shows a pan according to the invention with a treated functional surface according to the invention,

FIG. 14 shows another pan according to the invention with a functional surface treated according to the invention, and

FIG. 15 shows a baking mold according to the invention with a surface treated according to the invention.

### DETAILED DESCRIPTION

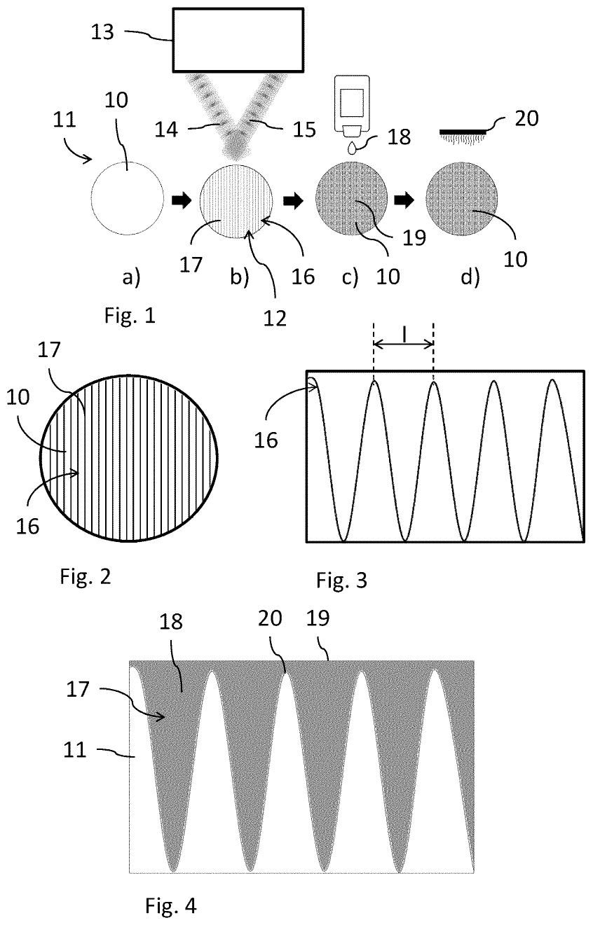

FIG. 1 shows in four steps a) to d) the process of an embodiment of the method according to the invention for surface treating a functional surface 10 of a cooking apparatus 11, which in the illustrated exemplary embodiment is the surface 10 of a frying pan on which food to be cooked is to be fried.

In step a) in FIG. 1, the cooking apparatus 11 is provided with an untreated functional surface 10. In this state, the functional surface 10 does not yet have any structuring 12 and is, for example, polished during the manufacture of the cooking apparatus 11.

The cooking apparatus 11 is provided in a laser-processing apparatus 13 according to the method according to the invention, which is shown schematically in step b) in FIG. 1. With the aid of the laser-processing apparatus 13, the functional surface 10 of the cooking apparatus 11 is structured by means of interference between two laser beams 14, 15 which are deflected at a finite angle to each other according to the step b) and each have pulse durations of about 10 ns. Therefore, these are short pulses that interfere with each other in the region of the functional surface 10 in order to create a structuring 12 of the functional surface 10 of the cooking apparatus 11.

In the exemplary embodiment shown in FIG. 1, a profile 16 is produced with linear indentations 17 which are arranged perpendicular to their direction of extension and offset from each other. The profile 16 of the functional surface 10 of the cooking apparatus 11, created by the structuring 12, is shown enlarged in FIG. 2. The indentations 17 each have a depth of 1 μm, a width of 5 μm, and an approximately sinusoidal cross-sectional profile; this profile is shown in FIG. 3, wherein, for illustrative reasons, the y-axis, which is oriented normal to the functional surface 10, is scaled differently from the x-axis, wherein the x-axis is oriented parallel to the width of the indentations 17. The aspect ratio of the indentations 17, i.e., the ratio between the depth and the width of the indentation 17, essentially corresponds to 0.2. Perpendicular to their direction of extension, the indentations 17 are arranged at a distance of 5 μm, such that a lateral period l of the profile of the functional surface in the sense of the invention of 5 μm results. FIG. 3 shows a schematic section through the structured functional surface 10 of the cooking apparatus 11, from which in particular the sinusoidal course of the indentations 17 and their lateral period I can be seen.

The structuring 12 takes place in a single work step substantially on the entire functional surface 10 of the cooking apparatus 11, leads to a surface activation of the functional surface 10 due to an increase in the functional surface 10, and therefore serves as a surface pretreatment in the sense of the invention.

After structuring the functional surface 10 by the laser-processing apparatus 13, a fat-containing lubricant 18, which in the present embodiment is cooking oil, is applied to the therefore structured, pretreated functional surface 10. The lubricant 18 enters in particular the indentations 17 and wets the entire functional surface 10 of the cooking apparatus 11 as evenly as possible. The lubricant 18 forms an approximately flat layer 19 with a thickness of 100 nm on the cooking apparatus 11, which, in the sense of the invention, corresponds to the distance from the tip 20 of an indentation 17 to the surface of the layer 19 of the lubricant 18.

This is due, for example, to capillary forces that form in the microstructure region as a result of the structuring 12 of the functional surface 10 and draw the lubricant 18 into the indentations. The lubricant 18 will remain adhered there, at least temporarily. The therefore modified functional surface 10 is shown in step c) from FIG. 1. The flat layer 19 of the lubricant 18 is also shown schematically in the section of the functional surface 10 according to FIG. 4.

Subsequently, according to step d) from FIG. 1, the cooking apparatus 11 is thermally treated with the lubricant 18 at 250° C. for a duration of 30 min, which in the illustrated exemplary embodiment is carried out by means of a heating medium 20 arranged at a distance from the cooking apparatus 11, wherein the heating medium 20 is shown schematically in step d). The temperature is chosen such that it is below the smoke point of the lubricant 18—in this case, the cooking oil-but is still sufficiently high to cause, for example, polymerization, oxidation, and hydrolysis of the lubricant 18. Decomposition products of these reactions are deposited in the indentations 17 of the structured functional surface 10, which are also referred to as microcavities, and adhere particularly well due to the increased surface region caused by the structuring 12, and form a friction-reducing layer 19 or film, which is also referred to as a “tribofilm.” This layer 19, in combination with the structuring 12 of the functional surface 10 in the micrometer range, causes an improvement in the non-stick properties and also an improvement in the corrosion properties of the functional surface 10 of the cooking apparatus 11 treated according to the invention.

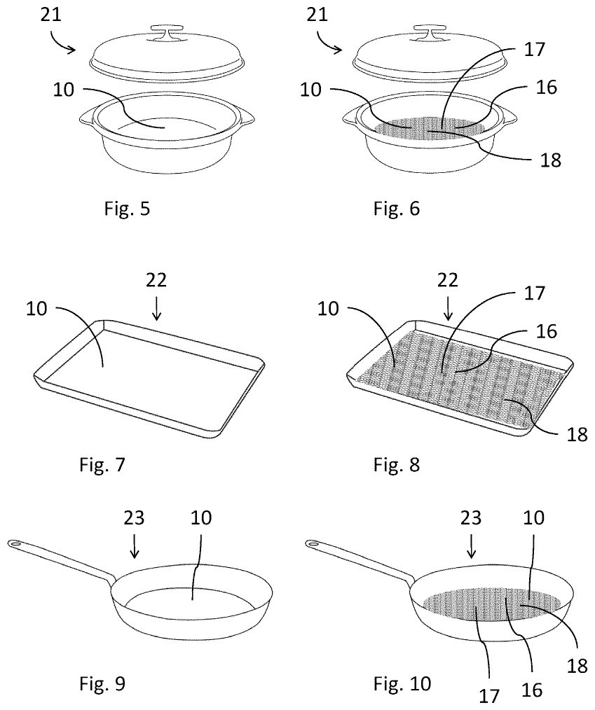

FIG. 5 shows a cooking pot 21 with an untreated functional surface 10, which can also be used as a braising pot or roasting pan. In contrast, FIG. 6 shows the cooking pot 21 from FIG. 5 with the functional surface 10 treated according to the invention, which in particular has the profile 16 with the indentations 17 and the lubricant 18 applied thereto. FIG. 7 shows a baking tray 22 with an untreated surface, and FIG. 8 shows the baking tray 22 with the functional surface 10 treated according to the invention, which is provided with the profile 16 with the indentations 17 and on which the lubricant 18 is applied. FIG. 9 shows a frying pan 23 with an untreated functional surface 10, and FIG. 10 shows one treated according to the invention.

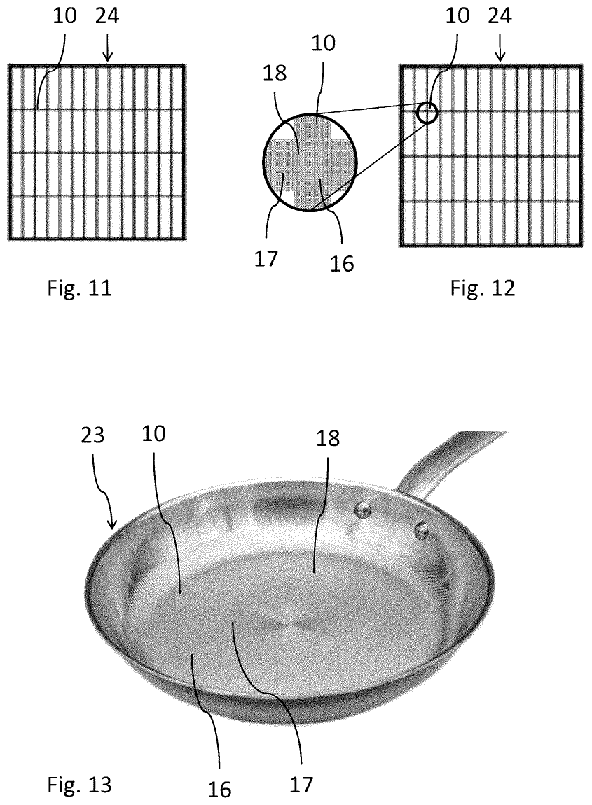

FIG. 11 shows a grill rack 24 with an untreated functional surface which corresponds at least to the top of the grill rack 24. FIG. 12 shows the grill rack 24 from FIG. 11 with the functional surface 10 treated according to the invention, which is shown enlarged in a detail in FIG. 12 and has the already described profile 16 with the indentations 17 and with the lubricant 18.

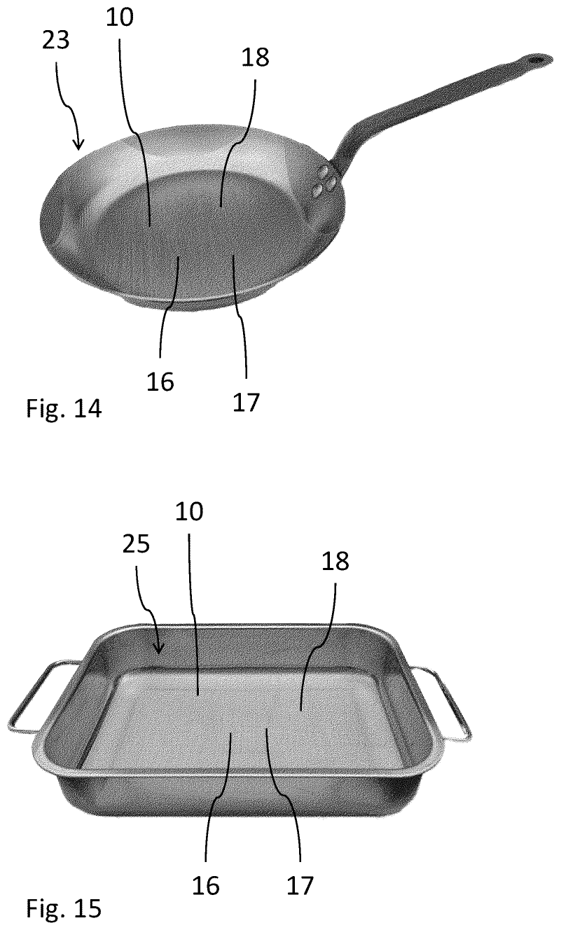

FIG. 13 shows a photographic representation of a frying pan 23 made of stainless steel, the functional surface 10 of which is largely treated according to the invention and as such has the profile 16 with the indentations 17 as well as the lubricant 18. FIG. 14 shows a photographic representation of another frying pan 23 which, however, unlike the frying pan 23 from FIG. 13, is made of carbon steel. The functional surface 10 of this pan 23 is also provided with the profile 16 with the indentations as well as with the lubricant 18. FIG. 15 shows a photographic representation of a baking mold, the functional surface 10 of which is largely treated according to the invention and has the profile 16 with the indentations 17 as well as the lubricant 18.,

The invention being thus described, it will be obvious that the same may be varied in many ways. Such variations are not to be regarded as a departure from the spirit and scope of the invention, and all such modifications as would be obvious to one skilled in the art are to be included within the scope of the following claims.

What is claimed is:

1. A method for surface-treating a functional surface of a cooking apparatus for cooking food to be cooked, the method comprising:
providing the cooking apparatus in a laser-processing apparatus;
structuring the functional surface of the cooking apparatus via the laser-processing apparatus, the laser-processing apparatus structuring the functional surface via at least one laser beam that has at least temporary pulse durations of at most 500 ns;
creating a profile with at least one indentation on the functional surface via the structuring;
applying a lubricant to the structured functional surface; and
thermally treating the structured functional surface having the lubricant at a temperature between 50°C and 700°C in order to obtain the treated functional surface.

2. The method according to claim 1, wherein the structuring of the functional surface of the cooking apparatus is carried out via the laser-processing apparatus via interference of at least two laser beams.

3. The method according to claim 1, wherein the at least one laser beam or at least two laser beams which interfere with one another, have pulse durations between 1 ns and 20 ns, at least temporarily.

4. The method according to claim 1, wherein the at least one indentation of the functional surface is produced with a dimension or a depth relative to an unstructured region of the functional surface between 10 nm and 50 μm, or between 100 nm and 15 μm, or between 1 μm and 25 μm.

5. The method according to claim 1, wherein at least one group of indentations is produced in a periodic pattern on the functional surface.

6. The method according to claim 5, wherein the group of indentations in the periodic pattern on the functional surface is produced having a lateral period between 10 nm and 50 μm, between 100 nm and 15 μm or between 1 μm and 25 μm, in at least one direction along the functional surface.

7. The method according to claim 1, wherein the indentations or the group of indentations have a lateral extent in a direction parallel to a direction of the lateral period, between 10 nm and 49 μm, or between 10 nm and 10 μm.

8. The method according to claim 1, wherein the indentations or the group of indentations have an aspect ratio between 0.01 and 5, and wherein the aspect ratio corresponds to a ratio of the depth of the indentation to a lateral extent of the indentation.

9. The method according to claim 1, wherein the structuring of the functional surface is carried out in a single work step.

10. The method according to claim 5, wherein at least two groups of indentations are produced in a periodic pattern, wherein the lateral period of the first group of indentations is arranged at an angle other than 0° to the lateral period of the second group of indentations or at an angle of 90°.

11. The method according to claim 1, wherein the lubricant is an oil-containing lubricant, oil, food-grade oil, vegetable oil, sunflower oil, rapeseed oil, food-grade chain oil, fat, food-grade fat, vegetable fat, animal fat, synthetic fat, polyalkylene glycol, dry lubricant, food-grade dry lubricant, solid lubricant, and/or carbon-based lubricant, graphite.

12. The method according to claim 1, wherein the thermal treatment of the structured functional surface is carried out for a duration of at least 1 min.

13. A cooking apparatus comprising a functional surface for cooking food to be cooked, wherein the functional surface is treated according to the method according to claim 1.

14. The cooking apparatus according to claim 13, wherein the cooking apparatus and/or its functional surface is formed of aluminum, iron, cast iron, stainless steel, stainless steel with a magnetic component, ceramic, and/or fiber-reinforced material.

15. The cooking apparatus according to claim 13, wherein the cooking apparatus has a layer system with at least two layers, wherein a first layer of aluminum and a second layer of stainless steel are provided, and wherein the functional surface corresponds to the second layer.

16. The cooking apparatus according to claim 13, wherein the functional surface of the cooking apparatus has at least one group of indentations, wherein the indentations:
have a lateral period between 100 nm and 50 μm; and/or
have a lateral dimension or a lateral width between 10 nm and 49 μm, between 10 nm and 10 μm, or between 1 μm and 25 μm; and/or
have an aspect ratio between 0.01 and 5, or between 0.01 and 1, the aspect ratio corresponding to a ratio of the depth of the indentation to the lateral dimension of the indentation.

17. The cooking apparatus according to claim 13, wherein the lubricant on the functional surface has a layer thickness between 10 nm and 500 μm after the thermal treatment.

18. The cooking apparatus according to claim 13, wherein the cooking apparatus is a grilling apparatus, frying apparatus, baking apparatus, and/or braising apparatus.
